(19) United States
(12) Patent Application Publication
(10) Pub. No.: US 2013/0284473 A1
(43) Pub. Date: Oct. 31, 2013

(54) HAND-HELD MACHINE TOOL AND CONTROL METHOD

(71) Applicant: HILTI AKTIENGESELLSCHAFT, Schaan (LI)

(72) Inventors: Markus Hartmann, Mauerstetten (DE); Eduard Pfeiffer, Halblech (DE)

(21) Appl. No.: 13/865,747

(22) Filed: Apr. 18, 2013

(30) Foreign Application Priority Data
Apr. 19, 2012 (DE) 102012206452.4

(51) Int. Cl. B25D 17/24

(52) U.S. Cl. CPC B25D 17/245
USPC 173/1; 173/212

(57) ABSTRACT

A hand-held machine tool includes a tool accept for mounting a chiseling tool on an operating axis. A pneumatic hammer mechanism includes an exciter, driven back and forth by a motor about a stroke between a dead point distant from the tool and a dead point near the tool, a hammer moved back and forth on the operating axis between a reversal point distant from the tool and a point of impact, and a pneumatic chamber sealed by the exciter and the hammer, which couples the movement of the hammer to the movement of the exciter. A damping device increases the pressure in the pneumatic chamber when the exciter during its motion in the direction to the dead point distant from the tool has approached to less than half the stroke to the dead point distant from the tool.

### CROSS-REFERENCE TO RELATED APPLICATIONS

The present application claims priority to German Patent Application No. DE 10 2012 206 452.4, filed Apr. 19, 2012, which is hereby incorporated by reference herein in its entirety.

### FIELD

The present technology relates to a chiseling hand-held machine tool, e.g., a hand-held hammer drill or a hand-held breaker and a corresponding control method.

### BACKGROUND

DE 28 54 953 C2 describes a hammer drill that includes a hammer, which is excited via an interposed pneumatic chamber by a motor-driven piston. The effectiveness and the power level of the hammer drill is increased by a radial compressor. Supercharged air in the radial compressor flows through openings, which can be covered by the hammer, into the pneumatic chamber. The radial compactor increases the air pressure in the pneumatic chamber particularly at the point of time or during the period causing the optimal acceleration of the hammer. Shortly before impact upon a rivet set the hammer is provided with additional thrust in order to increase the impacting energy.

The user must apply a holding force when the energy is transferred to the hammer. The transfer occurs periodically with the hammer frequency of the hand-held machine tool, typically ranging from 10 Hz to 100 Hz, causing the user to experience the holding force as vibrations. The vibrations shall be low for physiological reasons. Accordingly the impact energy cannot be increased infinitely.

### BRIEF SUMMARY

A hand-held machine tool according to the certain aspects of the present technology includes a tool accept for mounting a chiseling tool in an operating axis. The machine tool includes a pneumatic hammer mechanism, which in turn includes an exciter driven by a motor back and forth by a stroke between a dead point distant from the tool and a dead point near the tool, a hammer moved back and forth on the operating axis between a reversal point distant from the tool and a point of impact, and a pneumatic chamber sealed by the exciter and the hammer, which couples the movement of the hammer to the movement of the exciter. A damping device increases the pressure in the pneumatic chamber when the exciter, during its motion in the direction to the dead point distant from the tool, has approached the dead point distant from the tool to less than half the stroke.

Under ambient pressure a pneumatic chamber or air spring only weakly couples the hammer to the exciter. The pressure increased by the damping device leads to an effectively extended coupling. An energy transfer can therefore occur over an extended period of time, which lowers the holding forces required. The maximum pressure in the pneumatic chamber can be lowered, here.

The damping device increases the pressure in the pneumatic chamber during its motion toward the dead point distant from the tool preferably before the exciter has approached the dead point distant from the tool to less than 10% of the stroke. The pressure is increased before the exciter has reached the dead point.

In at least one embodiment, the damping device includes a pump, which is connected to a pneumatic chamber via a path-controlled valve device depending on the position of the exciter. The exciter can control the valve device directly by its own body or indirectly by an interposed mechanic or a sensor determining its position using a responding actuator. The pump is preferably provided with a drive decoupled from the hammer.

The valve device may represent an opening to the pneumatic chamber, for example, releasing the exciter when said exciter has approached the dead point distant from the tool to less than half a stroke.

In at least one embodiment, a pressure-controlled valve is arranged downstream in reference to the path-controlled valve device, interrupting any air flow from the pneumatic chamber to the damping device. While the path-controlled valve device marks the beginning of an air flow into the pneumatic chamber, the pressure-controlled valve seals the connection to the pump before the path-controlled valve device closes. The point of time for opening the entire valve arrangement can therefore be adjusted at a greater distance from the dead point distant from the tool as the point of time for the closing.

In at least one embodiment, the damping device adjusts the pressure in the pneumatic chamber to at least 1.5 bar and/or no more than 3.0 bar. The increase of the pressure leads to a slow-down of the hammer at its return movement. The pressure therefore may not be selected excessively strong because otherwise the hammer fails to return.

In at least one embodiment, the damping device maintains the pressure in the pneumatic chamber for at least 40% of a period to more than 2 bar. Preferably the pressure in the pneumatic chamber reaches the pressure of more than 2 bar already prior to the dead point of the exciter distant from the tool. The damping device can initially actively increase the pressure and then ensure the maintenance of the pressure, for example by sealing the pneumatic chamber.

In at least one embodiment, the damping device reduces the pressure in the pneumatic chamber during the motion of the hammer in the direction towards the exciter when the hammer is distanced by less than one third of the path of the point of impact from the rear reversal point of the point of impact. The pressure increased by the damping device depending on the position of the exciter leads to a slowing of the hammer on its return path. The initial reduction can compensate the slow-down and keep the period constant. In some embodiments, the damping device reduces the pressure in the pneumatic chamber to a value between 0.3 bar and 0.7 bar.

In at least one embodiment, the damping device includes a pump, which is connected to the pneumatic chamber via a valve device controlled by the hammer. The start for developing the vacuum in the pneumatic chamber is preferably controlled exclusively depending on the position of the hammer.

In at least one embodiment, the valve device controlled by the hammer includes an opening to the pneumatic chamber, which is released by the hammer when the hammer is distanced from the point of impact by less than one third of the distance of the point of impact from the rear reversal point.

According to some embodiments of the present technology, a control method for the hand-held machine tool increases the pressure in the pneumatic chamber by a pump, when the exciter during its motion in the direction towards the dead point distant from the tool has approached the dead point distant from the tool to less than half the stroke. In some embodiments, the increase of the pressure may be triggered exclusively based on the position of the exciter.

### BRIEF DESCRIPTION OF THE DRAWINGS

FIG. 1 is a hammer drill according to certain aspects of the present technology.

FIGS. 2 to 5 illustrate a hammer mechanism of the hammer drill in four operating positions.

FIG. 6 is a schematic path curve of the exciter and the hammer of the hammer mechanism.

FIG. 7 is an illustration of the progression of the pressure in the hammer mechanism over time.

FIG. 8 is an illustration of the amount of air in the hammer mechanism over time.

Identical elements or elements with identical functions are identified in the figures by the same reference characters, unless stipulated otherwise.

### DESCRIPTION OF EMBODIMENTS

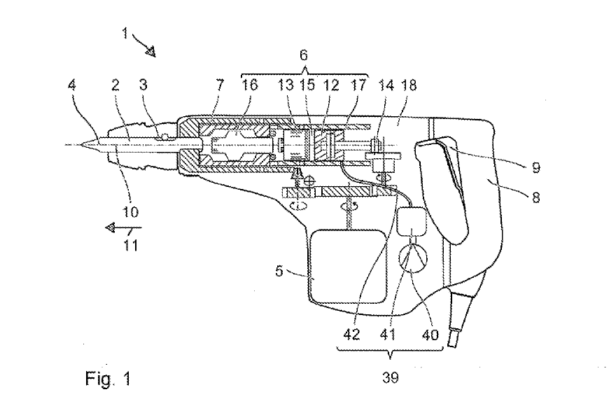

FIG. 1 shows a hammer drill 1 schematically as an example of a chiseling hand-held machine tool. The hammer drill 1 comprises a tool accept 2, in which the end of a shaft 3 of a tool can be inserted, e.g., a drill bit 4. A motor 5 forms the primary drive of the hammer drill 1, which drives a hammer mechanism 6 and a drive shaft 7. A user can guide the hammer drill 1 via a handle 8 and start operation of the hammer drill 1 via a system switch 9. During operation the hammer drill 1 continuously rotates the drill bit 4 about an operating axis 10 and can here drive the drill bit 4 in the direction of impact 11 along the operating axis 10 into a base.

The hammer mechanism 6 may be a pneumatic hammer mechanism 6, for example. An exciter 12 and a hammer 13 are guided in a mobile fashion in the hammer mechanism 6 along the operating axis 10. The exciter 12 is coupled via an eccentric 14 or a wobble finger to the motor 5 and forces to a periodic linear motion. An air spring formed by a pneumatic chamber 15 between the exciter 12 and the hammer 13 couples a motion of the hammer 13 to the motion of the exciter 12. The hammer 13 can directly impact a rear end of the drill bit 4 or indirectly transfer a portion of its impulse to the drill bit 4 via an essentially stationary intermediate rivet set 16. The hammer 13 and the exciter 12 may, for example, be embodied as pistons, which are arranged in a guide tube 17. The hammer mechanism 6 and the other drive components may be arranged inside a machine housing 18.

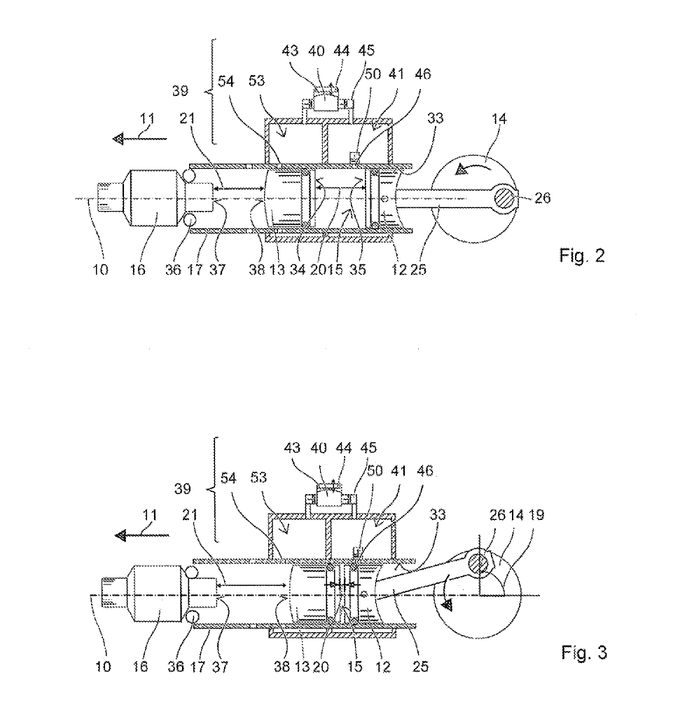

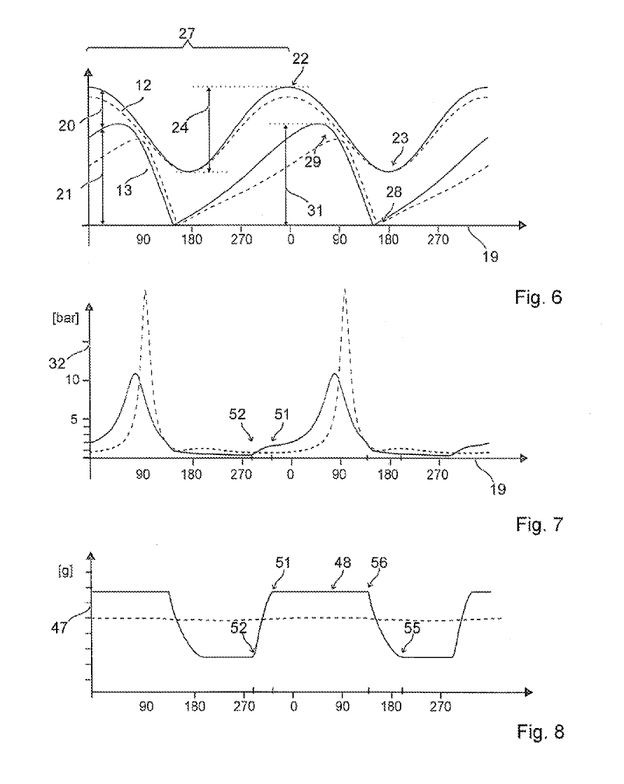

FIG. 2 through FIG. 5 show an exemplary embodiment of the hammer mechanism 6 in four subsequent phases of the motion of the exciter 12. The relative dimensions of the hammer mechanism 6 are schematic and only serve illustrating purposes of the mechanic design. FIG. 6 shows the motion of the exciter 12 and the hammer 13 via an angle 19 representing time. The curves are taken from a series of measurements. The distance 20 of the exciter 12 from the hammer 13 shown is true to scale of the distance 21 of the hammer from the rivet set 16, with the position of the latter coinciding with the x-axis. The exciter and the hammer of a classic hammer mechanism are displayed as dot-dash curves.

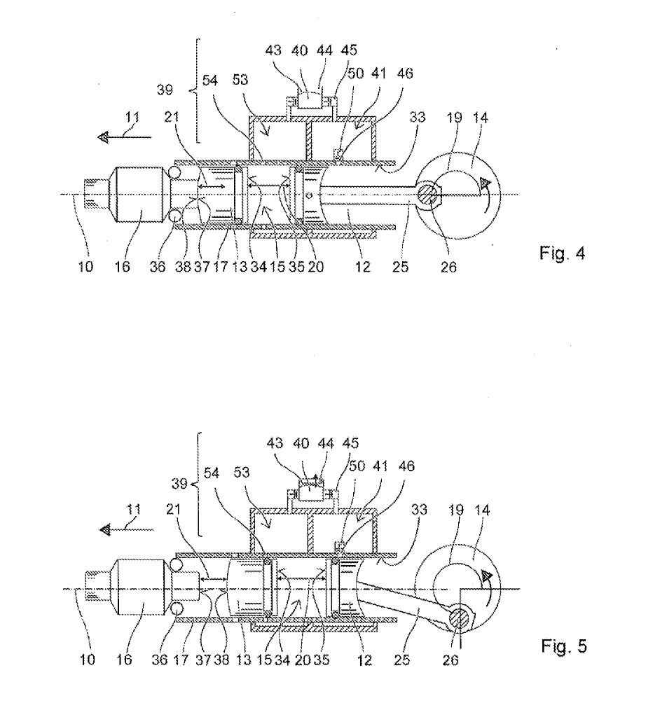

FIG. 2 shows the exciter 12 in its rear or dead position 22, distant from the tool. FIG. 3 shows the exciter 12 halfway between the rear dead point 22 and its front or dead point 23 near the tool. FIG. 4 shows the exciter 12 in its front dead point 23. FIG. 5 shows the exciter 12 halfway back to the rear dead point 22. In the following, the length of the distance between the front dead point 23 and the rear dead point 22 is called the stroke 24.

In the exemplary hammer mechanism 6, the exciter 12 is driven by the eccentric 14. A con-rod 25 connects an eccentric pin 26 to the exciter 12. The angular position 19 of the eccentric 14 and/or its eccentric pin 26 is stated as zero degrees for the following description, when the exciter 12 is located in its rear dead point 22 (FIG. 2). The phases shown in FIG. 3 through FIG. 5 are equivalent to an angular position 19 of 90 degrees, 180 degrees and/or 270 degrees. 360 degrees are equivalent to a period 27 or a concluded back and forth motion of the exciter 12. The angular position 19 is used synonymous to time, regardless if the eccentric 14 or another periodic drive is used for the exciter 12.

The hammer 13 moves periodically back and forth between the point of impact 28 and a reversal point 29 distant from the tool. In certain embodiments, the hammer 13 preferably reaches the reversal point 29 distant from the tool when the exciter 12 has moved away from the rear dead point 22 by 25% to 40% of the stroke 24 (FIG. 3). The hammer 13 reaches the point of impact shortly before the exciter 12 reaches the dead point 23 near the tool. It takes approximately the same time for the hammer 13 to move from the reversal point 29, distant from the tool, to the point of impact 28 than for the exciter 12 to move over half the stroke 24. In some embodiments, the path 31 traveled by the hammer 13 may be greater by 10% to 30% than the stroke 24 of the exciter 12.

A distance 20 of the exciter 12 from the hammer 13 changes periodically. The shortest distance 20 results when the hammer 13 reaches the rear reversal point 29. The change of volume of the pneumatic chamber 15 occurring here leads to a compression and/or decompression of the gas located in the pneumatic chamber 15. A force impacts the hammer 13 in the direction of impact 11 when the pressure in the pneumatic chamber 15 exceeds the ambient pressure and a force opposite the direction of impact 11 when the pressure in the pneumatic chamber 15 is lower than the ambient pressure. The pressure in the pneumatic chamber 15 adjusts to approximately the ambient pressure when the hammer 13 is in the position of impact 28. The volume assumed in the point of impact 28, i.e., the hammer 13 contacting the rivet set 16 and the exciter 12 being approximately halfway between the rear dead point 22 and the front dead point 23, is called the neutral volume in the following. FIG. 7 shows the pressure 32 in the pneumatic chamber 15 over time. The dot-dash line illustrates the pressure for a conventional hammer mechanism.

In the exemplary hammer mechanism 6, the exciter 12 is embodied as a piston, which is guided in a form-fitting fashion at the internal wall 33 of the guide tube 17. The hammer 13 is also embodied as a piston, form-fitting in reference to the guide tube 17. The volume of the pneumatic chamber 15 is therefore sealed in an air-tight fashion in the direction of impact 11 by a facial area 34 of the hammer 13, pointing opposite the direction of impact 11, opposite the direction of impact 11 by a facial area 35 of the exciter 12 pointing in the direction of impact 11, and in the radial direction by the guide tube 17. O-rings can be inserted in the circumference of the exciter 12 and the hammer 13 to compensate any tolerances.

During the operation of the hammer mechanism 6 the rivet set 16 in its normal position contacts a stop 36 opposite the direction of impact 11. Among other things, in its normal position the rivet set 16 is held to a base by the compression of the tool 4. The impact area 37 of the rivet set 16 pointing opposite the direction of impact 11 defines the point of impact 28. The hammer 13 impacts the point of impact 28 with a facial area 38 pointing in the direction of impact 11 onto the impact area 37 of the rivet set 16. If the rivet set 16 was not held in its normal position the hammer mechanism 6 preferably stops operating.

The hammer drill 1 may be provided with a damping device 39. The damping device 39 reduces the maximum rear loads stressing the user. T he exemplary damping device 39 is based on a pump 40, which increases the pressure 32 in the pneumatic chamber 15 in a controlled fashion depending on the position of the exciter 12. The pump 37 may be supported by a pressure chamber 41.

A pressure chamber 41 is arranged in the machine housing 18. The pressure chamber 41 is a closed chamber, for example provided with stiff or elastic walls. In the exemplary embodiment, the pressure chamber 41 represents a sheath surrounding the guide tube 17. In alternative embodiments, the pressure chamber 41 may be embodied as a rubber sphere or a separate tank with stiff walls, which are arranged for example spatially separated from the hammer mechanism 6 in the machine housing 18 and connected via a supply line 42 to the hammer mechanism 6. In some embodiments, the volume of the pressure chamber 41 ranges preferably from 50% to 200% of the neutral volume of the pneumatic chamber 15.

A pump 40 pumps air into the pressure chamber 41 in order to increase the pressure in the pressure chamber 41 to a value from 1.5 bar to 3 bar. The pressure in the pressure chamber 41 is higher than the ambient pressure, preferably by at least 0.5 bar and preferably by no more than 2.5 bar. The pump 40 is for example a membrane pump, whose membrane 43 is excited to oscillate by a motor or a Piezo element 44. A return valve 45 can interrupt a reverse flow of air from the pressure chamber 41 into the pump 40.

The pressure chamber 41 may be connected to the pneumatic chamber 15 via a valve 46. The valve 46 opens and closes depending on the position of the exciter 12. In some embodiments, the valve opens (point of time 52) when the exciter 12 has traveled on its return to the rear dead point 22 by more than half the stroke 24, no later than after it has traveled 90% of the stroke 24. The angular position 19 therefore ranges from 270 degrees to 342 degrees at the point of time the valve 46 opens. When the valve 46 is open, air flows out of the pressure chamber 41 into the pneumatic chamber 15.

FIG. 8 shows the amount of air 47 (mass) in the pneumatic chamber 15 applied over the y-axis. The dot-dash line discloses the amount of air of the conventional hammer mechanism of identical size. Its amount of air remains approximately constant, i.e., is equivalent to the amount of air of the neutral volume at ambient pressure. It is discernible that the amount of air in the pneumatic chamber 15 increases by at least 50%. In some embodiments, the pressure 32 in the pneumatic chamber 15 preferably reaches a pressure of 2 bar within 10% of the period 27 (36 degrees) starting from the opening of the valve 46. In particular, the pressure increases to more than 2 bar before the exciter 12 reaches the rear dead point (0 degrees).

The valve 46 closes at the point of time 48, path-controlled depending on the position of the exciter 12. The valve 46 closes at the latest when during its forward motion towards the front dead point 23 the exciter 12 has distanced by more than half the stroke 24 from the rear dead point 22 (90 degrees). In some embodiments, the valve 46 preferably closes only when the exciter 12 has moved away by more than 10% from the rear dead point 22 (approx. 10 degrees).

The exemplary valve 46 is an opening 46 in the guide tube 17. The exciter 12 ending flush with the internal wall 33 of the guide tube 17 forms the closing body of the valve 46. The valve 46 is closed when the exciter 12 covers the opening 49 with its jacket surface or its O-ring. The opening 46 is arranged along the operating axis 10 at the level of the facial area 35 and/or the O-ring, which assume this position when the exciter 12 opens and/or closes depending on the direction of motion of the valve 46.

Instead of closing the opening 46 directly by the exciter 12, a closure may be moved synchronous to the exciter 12 and be arranged as the closure body for the opening 49. The closure can be driven, for example, by the eccentric 14. The position of the opening 46 is therefore no longer dependent on the positions assumed by the exciter 12. Further, an electrically operated valve can be used instead of a mechanic actuator. A sensor detects for example the position of the exciter 12 and accordingly switches the valve to the detected position.

Preferably a return valve 50 is arranged downstream in reference to the path-controlled valve 46. The return valve 50 prevents any air from flowing back from the pneumatic chamber 15 into the pressure chamber 41 when the pressure 32 in the pneumatic chamber 15 exceeds the pressure in the pressure chamber 41. The threshold for the pressure 32, from which the return valve 50 closes, is equivalent to the pressure to which the pressure chamber 41 is raised by the pump 40.

Slightly before the exciter 12 reaches the rear dead point 22, the hammer 13 begins to catch up with the exciter 12. At the latest when the exciter 12 exceeds the rear dead point (FIG. 2) and begins its motion in the direction of impact 11, the distance 20 reduces between the exciter 12 and the hammer 13. The volume of the pneumatic chamber 15 reduces and the air is compressed by the exciter 12 and the hammer 13. The pressure 32 in the pneumatic chamber 15 rises to a value exceeding the one in the pressure chamber 41, and the return valve 50 closes. In some embodiments, the point of time 51 of the closing is approximately between 5% and 15% of the period 27 after the opening (52), preferably clearly before the exciter 12 has reached its rear dead point 22 and clearly before the path-controlled valve 46 closes (48).

Finally, the pressure in the pneumatic chamber 15 reaches at least 8 bar, however preferably no more than 15 bar, e.g., no more than 12 bar, when the hammer 13 reaches the rear reversal point 29 (FIG. 3). The comparable conventional hammer mechanism reaches a maximum pressure of 20 bar.

In some embodiments, the pressure in the pneumatic chamber 15 is greater than the ambient pressure over at least 40%, preferably at least 50% of the period 27. The pressure during compression in the rear reversal point 29 of the hammer 13 is moderate, though, ranging in value from 6 bar to 10 bar. The corresponding moderate pressure change only needs to be compensated by the user with moderate pressure. The pressure chamber 41 shows a damping effect. In conventional hammer mechanisms without the pressure chamber 41 high pressure develops in the pneumatic chamber 15 only over 20% to 25% of the period 27. Here, the peak value of the compression increases to at least 15 bar, in order to allow transmitting the same energy from the exciter 12 to the hammer 13.

A vacuum chamber 53 is arranged in the machine housing 18. The vacuum chamber 53 is a closed chamber with stiff walls. For example, the vacuum chamber 53 may surround the guide tube 17 as a sheath. In some embodiments, the volume of the vacuum chamber 53 preferably ranges from 50% to 200% of the neutral volume. The pump 40 suctions air out of the vacuum chamber 53 in order to lower the pressure in the vacuum chamber 53 to a range from 0.3 bar to 0.7 bar. In the embodiment shown, the pump 40 pumps air out of the vacuum chamber 53 into the pressure chamber 41. In alternative embodiments a separate pump may be provided for each of the chambers 41, 53. Further, the pump 40 may be provided with a pressure-controlled valve, which allows a suctioning of air from the environment in addition to the air out of the vacuum chamber 53.

The vacuum chamber 53 is connected to the pneumatic chamber 15 by an opening 54 in the guide tube 17. Together with the hammer 13 the opening 54 forms a path-controlled valve. The jacket surface or the O-ring of the hammer 13 covers the opening 54 in order to seal the valve 54. The valve 54 is preferably open or closed when the exciter 12 reaches the point of impact 28. Air flows from the pneumatic chamber 15 into the vacuum chamber 53. The amount of air in the pneumatic chamber 15 is reduced by at least 30%. Preferably the pressure in the pneumatic chamber 15 reduces to less than 0.7 bar before the exciter 12 reaches the front dead point 23 (180 degrees). The valve 54 closes at the point of time 55, before the hammer 13 has traveled one third of its path 31 to the rear reversal point 28. The pressure 32 in the pneumatic chamber 15 preferably remains below the ambient pressure for approximately 20% to 30% of the period 27 of the exciter 12.

The valve 54, exemplarily embodied with the hammer 13 as a closing body, opens at the point of time 56 before the hammer 13 reaches the point of impact 28. Although by the pressure reduction in the pneumatic chamber 15 a braking effect was to be expected upon the hammer 13 it only shows negligible effect by the open valve 54.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A hand-held machine tool with a tool accept for mounting a chiseling tool on an operating axis, comprising:
a pneumatic hammer mechanism, comprising:
an exciter driven by a motor back and forth about a stroke between a dead point distant from the tool and a dead point near the tool;
a hammer moved back and forth on the operating axis between the reversal point distant away from the tool, and a point of impact; and
a pneumatic chamber sealed by the exciter, and the hammer coupling the movement of the hammer to the movement of the exciter; and
a damping device increasing the pressure in the pneumatic chamber when the exciter during its movement in the direction towards the dead point distant from the tool has approached the dead point distant from the tool by less than half the stroke.

2. A hand-held machine tool according to claim 1, wherein the damping device increases the pressure in the pneumatic chamber before the exciter in its motion in the direction towards the dead point distant from the tool has approached the dead point distant from the tool to less than 10% of the stroke.

3. A hand-held machine tool according to claim 1, wherein the damping device includes a pump connected to the pneumatic chamber via a valve device path-controlled depending on the position of the exciter.

4. A hand-held machine tool according to claim 3, wherein the path-controlled valve device includes an opening to the pneumatic chamber and the exciter releases the opening when the exciter has approached the dead point distant from the tool to less than half the stroke.

5. A hand-held machine tool according to claim 4, wherein a pressure controlled valve is arranged downstream in reference to the path-controlled valve device, which interrupts an air flow from the pneumatic chamber to the damping device.

6. A hand-held machine tool according to claim 1, wherein the damping device adjusts the pressure in the pneumatic chamber to at least 1.5 bar and/or no more than 3.0 bar.

7. A hand-held machine tool according to claim 6, wherein the damping device holds the pressure in the pneumatic chamber above 2 bar for at least 40% of a period.

8. A hand-held machine tool according to claim 1, wherein the damping device reduces the pressure in the pneumatic chamber during the motion of the hammer in the direction towards the exciter when the hammer is distant from the point of impact by less than one third of the path of the point of impact from the rear reversal point.

9. A hand-held machine tool according to claim 8, wherein the damping device lowers the pressure in the pneumatic chamber to a value of at least 0.3 bar and no more than 0.7 bar.

10. A hand-held machine tool according to claim 9, wherein the damping device includes a pump which is connected via a valve device controlled by the hammer to the pneumatic chamber.

11. A hand-held machine tool according to claim 10, wherein the valve device controlled by the hammer includes an opening to the pneumatic chamber, which is released by the hammer when the hammer is distanced by less than one third of the distance of the point of impact from the rear reversal point from the point of impact.

12. A control method for a hand-held machine tool comprising a tool accept for mounting a chiseling tool on an operating axis and a pneumatic hammer mechanism, with the hammer mechanism comprising an exciter driven back and forth by a motor about a stroke between a dead point distant from the tool and a dead point near the tool, a hammer moving on the operating axis back and forth between a reversal point distant from the tool and a point of impact, and a pneumatic chamber sealed by the exciter and the hammer, coupling the motion of the hammer to the motion of the exciter, the method comprising:
increasing the pressure in the pneumatic chamber by a pump when during its motion the exciter has moved in the direction towards the dead point distant from the tool to less than half the stroke to the dead point distant from the tool.

13. A control method according to claim 12, further comprising reducing the pressure in the pneumatic chamber by a pump when the hammer is distanced by less than one third of the path between the point of impact and the rear reversal point from the point of impact.
